(19) United States
(12) Patent Application Publication
(10) Pub. No.: US 2005/0183920 A1
(43) Pub. Date: Aug. 25, 2005

(54) Ratchet paw module structure

(76) Inventor: Tien Wang Hou, Tsao Tun Chen (TW)

Correspondence Address: Leong C. Lei, 1867 Ygnacio Valley Road, Walnut Creek, CA, 94598, US

(21) Appl. No.: 10/785,041

(22) Filed: Feb. 25, 2004

(51) Int. Cl. B60B 27/04

(52) U.S. Cl. 192/64

(57) ABSTRACT

A ratchet paw module structure is disclosed. The ratchet paw module is characterized in that the ratchet paw module has a first and second teeth slot formed at the ratchet block seat corresponding to the outer edge of the ratchet teeth element, and the first and second teeth slot are formed from three teeth slots of equal angle, and the first and the second teeth slot are alternately arranged, and the external edge of the ratchet block seat is formed into a first and second circular slot crossing over the middle section of the first and second teeth slot; the first and second teeth slot of the ratchet block seat are respectively provided with a ratchet block having a first and second ratchet block module, and the middle section of the individual ratchet block are formed with an engaging slot, and the engaging slot of each ratchet block is respectively corresponding to the first and second circular slot, and the ratchet block of the first and second ratchet block module are respectively mounted within the first and second teeth slot of the ratchet block seat using a first and second binding rim.

### BACKGROUND OF THE INVENTION

(a) Technical Field of the Invention

The present invention relates to ratchet paw module structure, and in particular, a ratchet paw structure with a plurality of ratchet block modules which are positioned alternately which allows different ratchet block modules to form different inclined angle, such that when the ratchet teeth element moves, the force of driving is greatly increased and the disengaging rotation is reduced.

(b) Description of the Prior Art

Ratchet paw module is commonly used in rotating components to provide unidirectional movement, such as the flywheel used in bicycles or exercisers. FIGS. 1, 1A are conventional ratchet paw structures used in flywheel. The ratchet paw structure comprises a ratchet block seat 10 and a ratchet seat 15, and the ratchet block seat 10 has a ratchet block module. On the ratchet block seat 10, the ratchet block module has three equidistant teeth slots 11, and a binding rim 13 is used to tight the ratchet block 12 to the corresponding teeth slot 11. The ratchet block seat 10 is mounted with a ratchet seat 15 having teeth disc at the outer edge thereof using a wheel cover 19. The inner edge of the ratchet seat 15 is formed with a series of ratchet teeth 16 corresponding to the ratchet block 12 to allow engagement or free engagement of the ratchet teeth seat 15 with corresponding ratchet block seat 10, and between the ratchet teeth seat 15 and the ratchet block seat 10 with the wheel cover, and ball bearing modules 17, 18 are provided to allow smooth rotation.

When the above conventional ratchet paw structure is used in the flywheel of bicycle, if the ratchet teeth element 15 rotates counter-clockwise direction, gap is formed between the top edge of the ratchet teeth 16 and the individual ratchet block 12. At this instance, the end section of the individual ratchet block 12 is moved upward due to the binding rim 13 acted at the top edge A of the engaging slot 120, and the ratchet teeth 16 of the ratchet teeth element 15 is engaged with the ratchet block 12, so that the ratchet element 15 drives the ratchet block seat 10. When the ratchet teeth element 15 drives rotate clockwise, the ratchet block 12, as a result of the tapered ratchet teeth 16, will move downward into the teeth slot 11 so that a disengaged rotation is formed between the ratchet teeth element 15 and the ratchet block seat 10. The ratchet paw module only has three ratchet blocks 12 and the force for driving the ratchet teeth element 15 is insufficient. This will therefore damage the ratchet teeth element 15. However, it is not suitable to increase the number of the ratchet block 12. As shown in FIGS. 2A, 2B and 3A, 3B when the binding rim 13 requires to drive three ratchet block 12, if the A point of any ratchet block 12 is higher or lower than the inner edge of the binding rim 13, the binding rim 13 will be actively adjusted to simultaneously contact, as shown in FIG. 2A and FIG. 3A, and the binding rim 13 can simultaneously drive the ratchet block 12 to engage with the ratchet teeth element 15. When the ratchet block 12 of the ratchet paw module is higher than three ratchet blocks, as shown in FIG. 2B and FIG. 3B, the binding rim 13 cannot ensure the simultaneously contact with all the ratchet blocks 12, the inner edge of the binding rim 13 and the ratchet block 12 produce gaps X, Y. This will further prevent the binding rim 13 to simultaneously drive the ratchet block 12. Thus, a part of the ratchet block 12 will not fully engage with the ratchet teeth element 15. Thus, the force that exerted is not even.

In order to increase the longevity of the binding rim 13, generally the binding rim 13 has to be undergone a heat treatment and therefore the binding rim 10 is not a real circular. As shown in FIGS. 4A, 5B, only three ratchet blocks 12 are employed, error can be rectified automatically. However, if there are more than three ratchet blocks 12, gap Z will be produced at the inner edge of the binding rim 13 and the A point of the ratchet block 12 and simultaneously engagement with the ratchet teeth 16 of the ratchet teeth element 15 cannot be achieved. This will cause damage to the ratchet teeth element 15.

There are also problems in the course of engagement. When the ratchet teeth element 15 moves a distance of half of the ratchet teeth 16 with respect to the ratchet block seat 10 and if the ratchet teeth element 15 is to be reversed to engage with the ratchet block seat 10, the ratchet teeth element 15 must go through half of the width of the ratchet teeth 16, which is a free rotation, before the engagement, and when the ratchet teeth element 15 moves more than ¾ width of the ratchet teeth 16, the ratchet teeth element 15 must return to a width of ¾ of the ratchet teeth 16 in order to engage smoothly. Due to the longer distance in reverse rotation, the momentum that produced is large which will damage the ratchet block 16 or the ratchet teeth 16, and the longevity of the ratchet paw structure is shortened.

In addition, if the reaction or the initiation of the engagement of the ratchet teeth is slow, there is a loss of force in the course of application.

Accordingly, it is an object of the present invention to provide a ratchet paw module structure, which will mitigates the drawbacks by shorten the free rotation distance and improving the rotating force.

### SUMMARY OF THE INVENTION

Accordingly, it is an object of the present invention to provide a ratchet paw module comprising a ratchet block seat and a ratchet teeth element, the ratchet block seat including a ratchet block module having a plurality of ratchet blocks and the ratchet teeth element mounted at the outer edge of the ratchet block seat and the inner edge of the ratchet teeth element formed with a series of ratchet teeth corresponding to the ratchet block module, characterized in that the ratchet paw module has a first and second teeth slot formed at the ratchet block seat corresponding to the outer edge of the ratchet teeth element, and the first and second teeth slot are formed from three teeth slots of equal angle, and the first and the second teeth slot are alternately arranged, and the external edge of the ratchet block seat is formed into a first and second circular slot crossing over the middle section of the first and second teeth slot; the first and second teeth slot of the ratchet block seat are respectively provided with a ratchet block having a first and second ratchet block module, and the middle section of the individual ratchet block are formed with an engaging slot, and the engaging slot of each ratchet block is respectively corresponding to the first and second circular slot, and the ratchet block of the first and second ratchet block module are respectively mounted within the first and second teeth slot of the ratchet block seat using a first and second binding rim.

Yet another object of the present invention is to provide a ratchet paw module structure, wherein the impact force during reverse rotation is minimized and the longevity of the ratchet paw structure is improved.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1, 1A are perspective exploded views of a conventional ratchet paw module.

FIGS. 2A, 2B are schematic views showing the movement of the conventional ratchet paw module, the movement point of the ratchet block being below the internal diameter of the binding rim.

FIGS. 3A, 3B are schematic views showing the movement of the conventional ratchet paw module, the movement point of the ratchet block being higher than the internal diameter of the binding rim.

FIGS. 4A, 4B are another schematic views showing the movement of the conventional ratchet paw module, showing that the binding rim being not real circular.

FIGS. 5, 5A, 5B are perspective exploded views of the ratchet paw module in accordance with the present invention.

FIG. 6 is a schematic view showing the movement of the conventional ratchet paw module, showing the operation of the ratchet paw module in the flywheel.

FIGS. 7, 7A, 7B are perspective exploded views of another preferred embodiment of the ratchet paw module of the present invention.

FIG. 8 is a schematic view of another preferred embodiment of the ratchet paw module in accordance with the present invention.

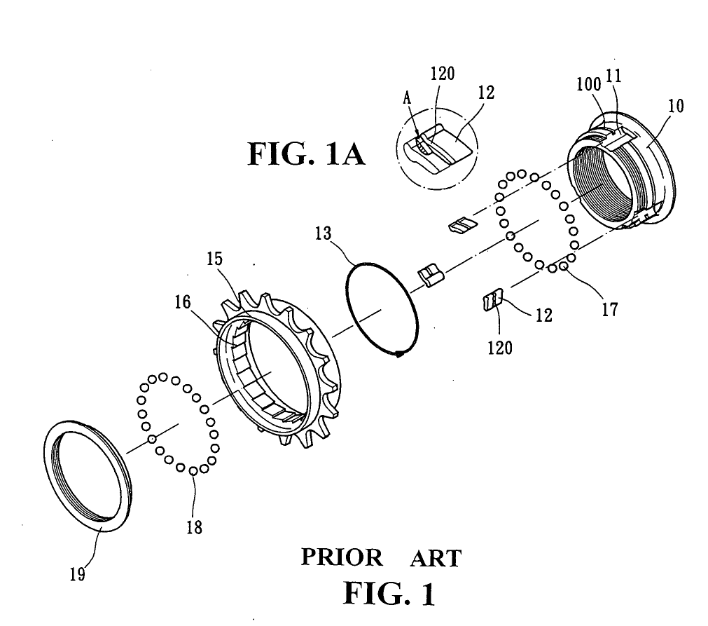

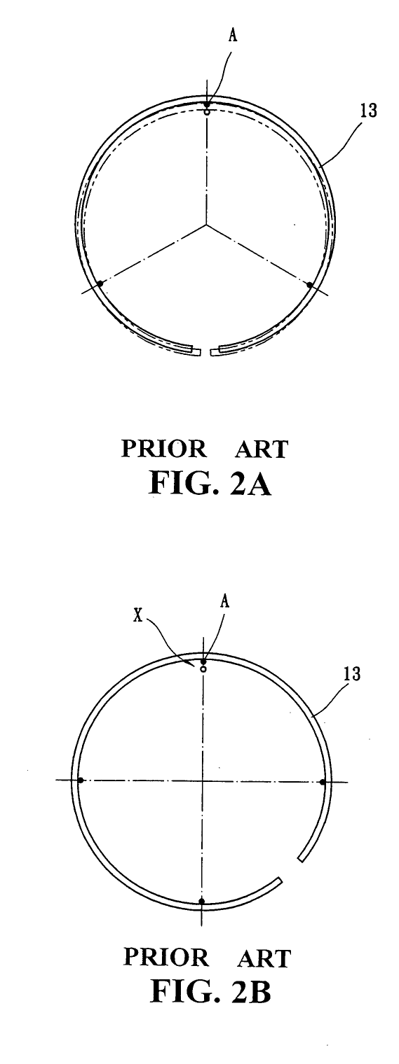

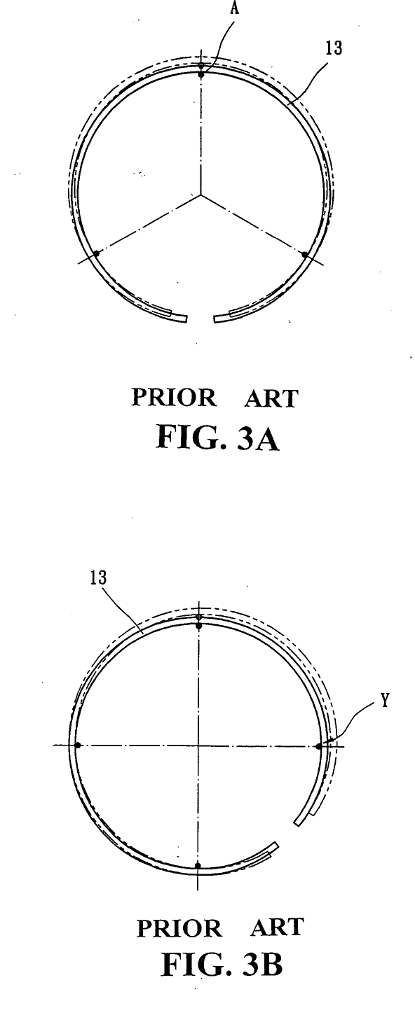

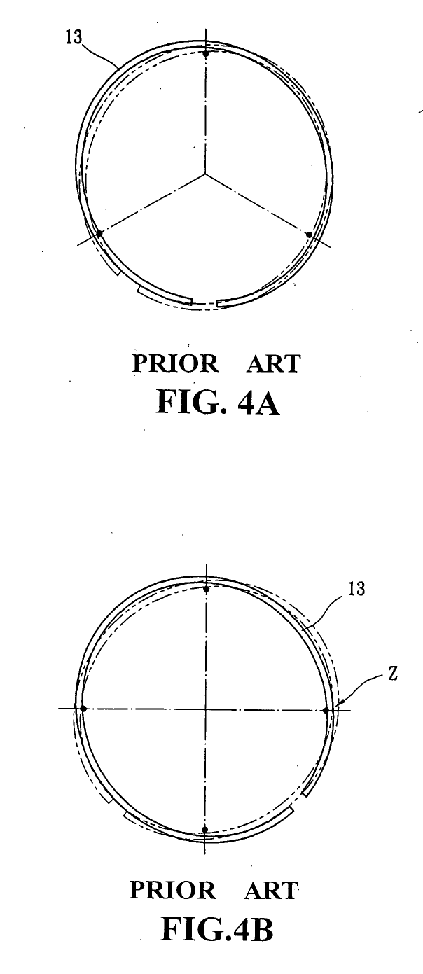

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

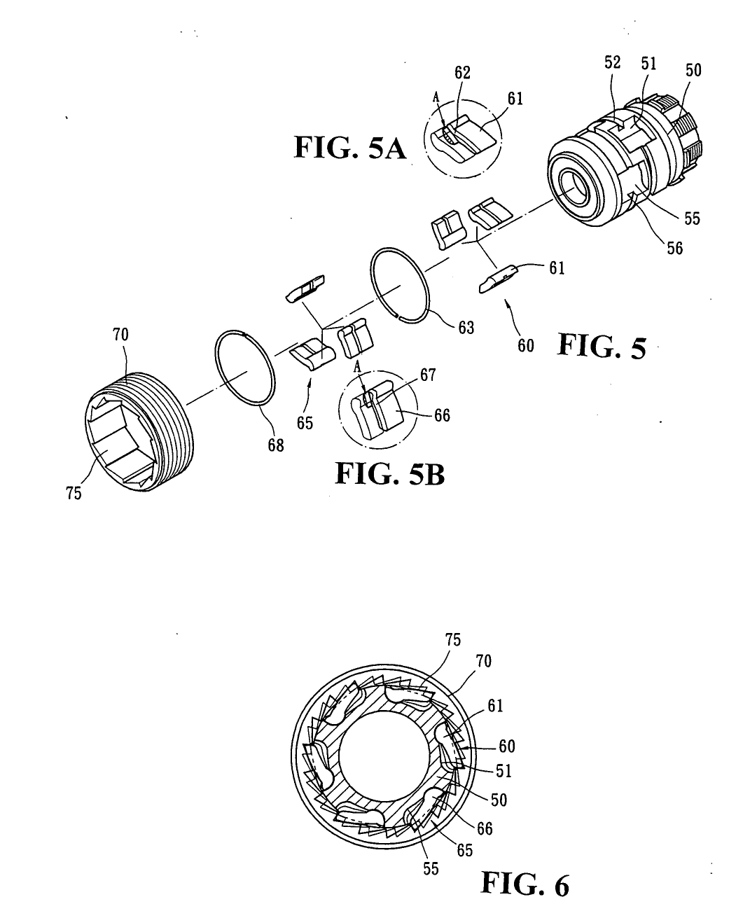

Referring to FIGS. 5, 5A, 5B and 6, the ratchet paw module includes a ratchet block seat 50 and a ratchet teeth element 70, and the ratchet block seat 50 is provided with a ratchet block module and the ratchet teeth element 70 is mounted at the outer edge of the ratchet block seat 50. The inner edge of the ratchet teeth element 70 is formed with a series of ratchet teeth 75 corresponding to the ratchet block module. The ratchet block seat 50 makes use of the ratchet block module to engage with the ratchet teeth 75 of the ratchet teeth element 70 for the ratchet block seat 50 to engage with the ratchet teeth element 70 or to rotate freely with respect to the ratchet teeth element 70. The ratchet block seat 50 or the ratchet teeth element 70 is either a driving element or a driven element. For instance, when it is used in flywheel of a bicycle, the ratchet block seat 50 is a driven component and if the outer edge of the ratchet teeth seat 70 is provided with a teeth disc, it becomes a driving component.

As shown in FIGS. 5, 5A, 5B the ratchet paw module is a ratchet block seat 50, at the outer edge of the corresponding ratchet teeth element 70, is formed with a firth teeth slot 51 and a second teeth slot 55, wherein the first and the second teeth slot 51, 55 are respectively formed by two teeth slots of equal angle and the first teeth slots 51, 55 are arranged alternately, and only ⅓ of the width of the two teeth slot are alternately arranged. The second teeth slot 55 is positioned between two adjacent first teeth slot 51, and each of the teeth slot of the first and second teeth slot 51, 55 is 60 degree. The external edge of the ratchet seat 50 is formed with a first and second circular slot 52, 56 crossing over the middle section of the first and second teeth slot 51, 55.

The first and second teeth slot 51, 55 of the ratchet block seat 50 are respectively provided with a first and a second ratchet block module 60, 65, and the first and second ratchet block module 60, 65 are constituted from three ratchet blocks 61, 66, and the middle section of each ratchet block 61, 66 is formed into an engaging slot 62, 67. When the ratchet blocks 61, 66 of the first and the second ratchet blocks 60, 65 are mounted on the first and the second teeth slots 55, 51 of the ratchet block seat 50, the engaging slot 62, 67 of each ratchet block 61, 66 are respectively corresponding to the first and second circular slots 52, 56, and the first and second binding rim 63, 68 are used to mount the ratchet blocks 61, 60 of the first and second ratchet block module 60, 65 to the first and second teeth slot 51, 55 of the ratchet block seat 50.

The first and second ratchet block module 60, 65 can respectively be mounted on the ratchet block seat 50. The ratchet teeth element 70 having ratchet teeth 75 at the inner edge thereof is mounted with a first and second ratchet block module 60, 65, and the ratchet teeth element 70 further drives the ratchet block seat 50 via the first and the second ratchet block module 60, 65. Thus, the ratchet paw module of the present invention provides a greater force.

Referring to FIGS. 5, 5A, 5B and 6, when the ratchet teeth element 70 of the ratchet paw module requires driving the ratchet block seat 50, the ratchet teeth element 70 is made to drive counter-clockwise. Thus, the individual ratchet block 61, 60 of the first and second ratchet block module 60, 65 of the ratchet block seat 50 will be affected by the force generated by the automatic retraction of the first and second binding rim 63, 68, and the end portion of each of the ratchet block 61, 66 are bent upward automatically such that the first and the second ratchet block module 60, 65 can simultaneously stop the ratchet teeth element 70. Thus, the ratchet teeth element 70 drives the ratchet block seat 50, and due to the fact that the ratchet teeth element 70 is provided with the ratchet block 61, 66 of the first and second ratchet block module 60, 65 in driving, the force of the ratchet paw module is greatly increased. Due to the increase of force for the ratchet blocks 61, 66, the damages to the ratchet blocks 61, 66 are avoided and the longevity of the ratchet blocks 61, 66 is increased.

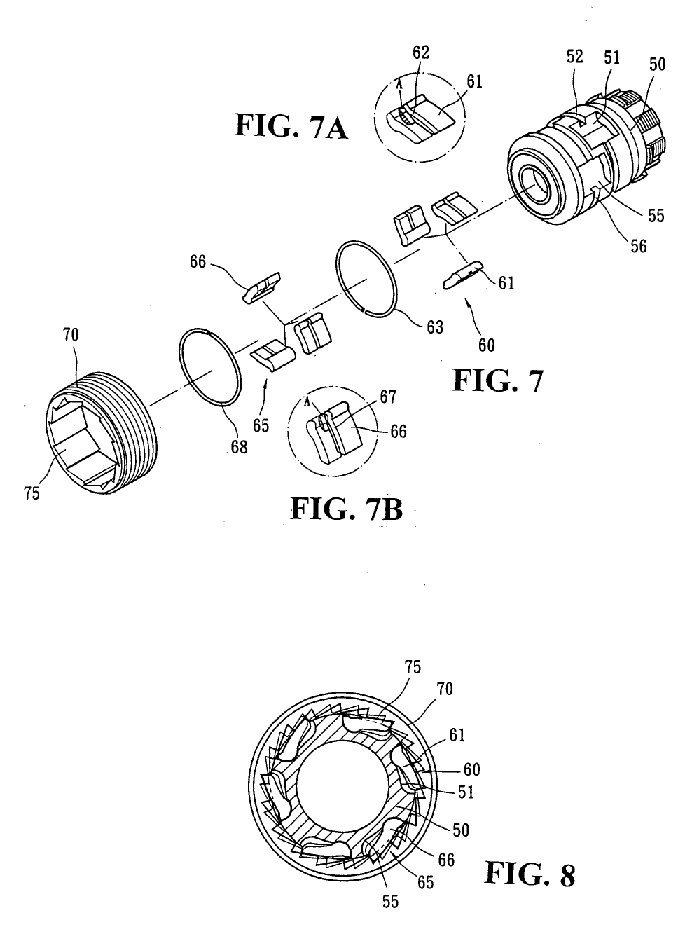

In another preferred embodiment, as shown in FIGS. 7, 7A, 7B and 8, the second teeth slot 55 of the ratchet block seat 50 positioned between two adjacent first teeth slot 51 is moved forward or backward eccentrically to a position of half the width of the ratchet teeth 75, and the ratchet block 61 of the first ratchet block module 60 is of different distance with the ratchet block 66 of the corresponding adjacent front and rear second ratchet block module 65. Thus, when the ratchet teeth element 70 rotates freely and is required to reverse, if the ratchet block 61 of the first ratchet block module 60 is in engagement with the ratchet teeth 75, the ratchet block 66 of the second ratchet block module 65, and the ratchet teeth 75 are at half position. When the ratchet block 61 of the first ratchet block module 60 is at half position with the ratchet teeth 75, the ratchet block 66 of the second ratchet block module 65 can engage with the ratchet teeth 75 without fully reversing.

In accordance with the present invention, the distance of reverse rotation for the ratchet teeth element 70 and the ratchet block seat 50 is shortened to half of the width of the ratchet teeth 75, the momentum force thus generated is smaller, and the ratchet teeth 75 and ratchet block 61, 66 will not be damaged by the momentum. This will effectively extended the longevity of the ratchet paw module. In addition, the reverse rotation is shortened and therefore, the reaction is rapid, and the initial of movement is quick, and thus the loss of force in transmission is avoided.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A ratchet paw module comprising a ratchet block seat and a ratchet teeth element, the ratchet block seat including a ratchet block module having a plurality of ratchet blocks and the ratchet teeth element mounted at the outer edge of the ratchet block seat and the inner edge of the ratchet teeth element formed with a series of ratchet teeth corresponding to the ratchet block module, characterized in that:
the ratchet paw module has a first and second teeth slot formed at the ratchet block seat corresponding to the outer edge of the ratchet teeth element, and the first and second teeth slot are formed from three teeth slots of equal angle, and the first and the second teeth slot are alternately arranged, and the external edge of the ratchet block seat is formed into a first and second circular slot crossing over the middle section of the first and second teeth slot;
the first and second teeth slot of the ratchet block seat are respectively provided with a ratchet block having a first and second ratchet block module, and the middle section of the individual ratchet block are formed with an engaging slot, and the engaging slot of each ratchet block is respectively corresponding to the first and second circular slot, and the ratchet block of the first and second ratchet block module are respectively mounted within the first and second teeth slot of the ratchet block seat using a first and second binding rim.

2. The ratchet paw module of claim 1, wherein the first and second teeth slot of the ratchet block seat having ⅓ of the width of the teeth slot being alternately arranged.

3. The ratchet paw module of claim 1, wherein the second teeth slot of the ratchet block seat is exactly positioned between two adjacent first teeth slot and the individual teeth slot of the first and second teeth slot are mounted at equal angle.

4. The ratchet paw module of claim 1, wherein the individual second teeth slot of the ratchet block seat positioned between two adjacent first teeth slots is eccentrically moved half the width of the ratchet teeth, and the adjacent ratchet block of the first and second ratchet block form with different inclined angle so as to shorten reverse rotation of the ratchet teeth element.

5. The ratchet paw module of claim 1, wherein the external edge of the ratchet teeth element is mounted with a teeth disc, and the ratchet block seat is mounted at the wheel shaft.
